(19) United States
(12) Patent Application Publication
(10) Pub. No.: US 2025/0194619 A1
(43) Pub. Date: Jun. 19, 2025

(54) PLANT FRESHNESS KEEPING COMPOSITION, PLATE-SHAPED BODY, STACK, LABEL, AND PACKAGING MATERIAL

(71) Applicant: SUMITOMO CHEMICAL COMPANY, LIMITED, Tokyo (JP)

(72) Inventor: Ayumu OGAWA, Ichihara-shi (JP)

(73) Assignee: SUMITOMO CHEMICAL COMPANY, LIMITED, Tokyo (JP)

(21) Appl. No.: 18/849,904

(22) PCT Filed: Feb. 14, 2023
(86) PCT No.: PCT/JP2023/004906

§ 371 Date: Sep. 23, 2024

(30) Foreign Application Priority Data
Mar. 25, 2022 (JP) 2022-050607

(51) Int. Cl. A23B 7/159

(52) U.S. Cl. CPC A23B 7/159

(57) ABSTRACT

A plant freshness-keeping composition comprising a (meth)acrylic resin, an anti-aging agent, and a porous material, and its application.

### TECHNICAL FIELD

The present disclosure relates to a plant freshness-keeping composition, a plate-shaped body, a stack, a label and a packaging material.

### BACKGROUND ART

It is known that plants, especially greengrocery such as vegetables and fruits gradually lose their freshness after harvesting. There is a need to develop technologies to keep the freshness.

For example, Patent Document 1 describes a meltable solid matrix comprising one or more hydrophobic substances and one or more hydrophilic substances, as well as a composition comprising one or more of the encapsulation complexes of volatile cyclopropene compounds encapsulated in a molecular encapsulating agent that is distributed in the matrix.

### CITATION LIST

### Patent Document

Patent Document 1: JP 2012-219096 A

### SUMMARY OF THE INVENTION

### Problems to be Solved by Invention

However, the composition described in the Patent Document 1 showed an increase in torque during kneading, and was difficult to prepare.

An object of an embodiment of the present disclosure is to provide a plant freshness-keeping composition that surpresses the excessive increase in torque during kneading.

Also, an object of an embodiment of the present disclosure is to provide a stack, a plate-shaped body, a label and a packaging material that each comprises the above plant freshness-keeping composition.

### Means to Solve Problems

The present disclosure encompasses the following embodiments.

<1> A plant freshness-keeping composition comprising a (meth)acrylic resin, an anti-aging agent, and a porous material.

<2> The plant freshness-keeping composition described in <1> wherein the (meth)acrylic resin comprises a structural unit derived from (meth)acrylic acid ester and a structural unit derived from α-olefin.

<3> The plant freshness-keeping composition described in <2> wherein the structural unit derived from (meth)acrylic acid ester is a structural unit derived from (meth)acrylic acid alkyl ester having alkyl group of 1 to 4 carbon atoms.

<4> The plant freshness-keeping composition described in <2> or <3> wherein the amount of the structural unit derived from (meth)acrylic acid ester is 5% by mass to 50% by mass relative to the total amount of the (meth)acrylic resin.

<5> The plant freshness-keeping composition described in any one of <1> to <4> wherein the amount of the (meth)acrylic resin is 15% by mass to 90% by mass relative to the total amount of the (meth)acrylic resin.

<6> The plant freshness-keeping composition described in any one of <1> to <5> wherein the composition further comprises a plasticizer.

<7> A plant freshness-keeping composition comprising a thermoplastic resin, an anti-aging agent, a porous material, and a plasticizer.

<8> The plant freshness-keeping composition described in <6> or <7> wherein the plasticizer is at least one selected from the group consisting of a fatty acid ester, an acetylcitrate ester, a phthalate ester, an isophthalate ester, and a terephthalate ester.

<9> The plant freshness-keeping composition described in any one of <1> to <8> wherein a viscosity at 150° C. is 100 Pa·s to 15000 Pa·s.

<10> The plant freshness-keeping composition described in any one of <1> to <9> wherein the anti-aging agent comprises a cyclopropene compound.

<11> The plant freshness-keeping composition described in any one of <1> to <10> wherein the porous material is an inorganic porous material comprising silicon.

<12> The plant freshness-keeping composition described in any one of <1> to <11> wherein the porous material comprises a diatomaceous earth.

<13> A plate-shaped body comprising the plant freshness-keeping composition described in any one of <1> to <12>.

<14> A stack comprising the first layer comprising the plant freshness-keeping composition described in any one of <1> to <12> and the second layer.

<15> A label comprising the plant freshness-keeping composition described in any one of <1> to <12>.

<16> A packaging material comprising the plant freshness-keeping composition described in any one of <1> to <12>.

### Effects of the Invention

According to an embodiment of the present disclosure, a plant freshness-keeping composition that suppresses an excessive increase in torque during kneading is provided. Also, according to an embodiment of the present disclosure, a stack, a plate-shaped body, a label and a packaging material each comprising the above plant freshness-keeping composition are provided.

### BRIEF DESCRIPTION OF DRAWINGS

FIG. 1 shows a result of the torque applied to the kneading machine during production in the Examples and the Comparative examples.

FIG. 2 shows a result of the temperature of the kneading during production in the Examples and the Comparative examples.

FIG. 3 shows a calculation result of the color difference in Example 1 and untreated example.

FIG. 4 shows a calculation result of the hardness difference in Example 1 and untreated example.

### MODE FOR CARRYING OUT THE INVENTION

Hereafter, the plant freshness-keeping composition, the stack, the plate-shaped body, the label and the packaging material are explained in detail.

In this specification, the numerical range indicated using “˜” means a range that includes the numerical values described before and after “˜” as the minimum value and the maximum value, respectively.

In the numerical range described in a stepwise manner in this specification, the upper limit values or the lower limit values of the numerical range may be replaced by the upper limit values or the lower limit values of the other numerical ranges described in a stepwise manner in this specification. In this specification, in the numerical range, the upper limit values or the lower limit values described in a particular numerical range may be replaced by the values indicated in the Examples.

In this specification, the amount of each ingredient in the composition means the total amount of a plurality of substances that is present in the composition unless otherwise specified, when there is a plurality of substances corresponding to each ingredient in the composition.

In this specification, the combination of two or more preferred embodiments is a more preferred embodiment.

In this specification, the term “step” encompasses an independent step but also any other step when the intended purpose of the step is achieved, even if it cannot be clearly distinguished from the other step(s).

In this specification, the term of “(meth)acrylate” is a concept that encompasses both acrylate and methacrylate. Also, the term of “(meth)acryl” is a concept that encompasses both acryl and methacryl.

### [Plant Freshness-Keeping Composition]

The plant freshness-keeping composition as the first embodiment of the present disclosure (hereinafter, referred to as “First composition”) comprises a (meth)acrylic resin, an anti-aging agent, and a porous material.

The plant freshness-keeping composition as the second embodiment of the present disclosure (hereinafter, referred to as “Second composition”) comprises a thermoplastic resin, an anti-aging agent, a porous material, and a plasticizer.

The description that is common to the first composition and the second composition may be simply referred to as “composition”.

According to the composition of the present disclosure, an excessive increase in torque during kneading can be suppressed. The reason for this is not clear, but it can be inferred as follows.

In the composition comprising an ethylene-vinyl acetate copolymer, an ethylene-vinyl acetatecopolymer is decomposed and cross-linked during kneading, resulted in the increase in the viscosity of the kneaded material and the torque. On the other hand, since the first composition of the present disclosure comprises a (meth)acrylic resin, it can be melted at a relatively low temperature and is not easily decomposed during kneading. Accordingly, it is considered that an excessive increase in torque during kneading can be suppressed.

It is considered that since the second composition of the present disclosure comprises a thermoplastic resin and a plasticizer, interactions between the resins become smaller during kneading, leading to a decrease in the melt viscosity of the kneaded material, and accordingly, an excessive increase in torque during kneading can be suppressed.

The composition of the present disclosure is for keeping plant freshness, and is used for keeping plant freshness. The plants are not particularly limited, but is for example, greengrocery and flowers. The composition of the present disclosure is preferably used to keep the freshness of greengrocery. That is, the composition of the present disclosure is preferably a composition for keeping the freshness of greengrocery.

The greengrocery is for example, fruits such as citrus, apple, pear, grapes, blueberry, persimmon, strawberry, pineapple, cherry, lychee, pomegranate, loquat, banana, melon, mango, papaya, kiwifruit, cherimoya, avocado, guava, plantain, plum, peach, passion fruit, apricot, breadfruit (breadfruit), pawpaw, durian, feijoa, dragon fruit, star fruit, rambutan, jujube, bell pepper, paprika, shishito, cucumber, eggplant, tomato, cherry tomato, pumpkin, bitter gourd, okra, sweet corn, edamame, snow pea, green beans, broad beans, and the others; vegetables such as plantain, spinach, Japanese tuna, mizuna, mibuna, asparagus, cucinsai, lettuce, thyme, sage, parsley, Italian parsley, rosemary, oregano, lemon balm, chives, lavender, salad burnet, lamb's ear, rocket, dandy lion, nasturtium, basil, arugula, watercress, moloheiya, celery, kale, leek, cabbage, Chinese cabbage, shungiku, saladana, sanchu, butterbur, navana, bok choy, honeywort, seri, cabbage, broccoli, cauliflower, myoga, daikon, carrot, burdock, radish, turnip, sweet potato, potato, nagaimo, yam, satoimo, ginenjo, yamatoimo, and the others; and fungus mushrooms.

### <First Composition>

The first composition of the present disclosure comprises a (meth)acrylic resin, an anti-aging agent, and a porous material.

### ((Meth)Acrylic Resin)

The first composition of the present disclosure comprises a (meth)acrylic resin. The (meth)acrylic resin comprised in the first composition of the present disclosure may be only one species thereof, or may be two or more species thereof.

Since the first composition of the present disclosure comprises a (meth)acrylic resin, an excessive increase in torque during kneading is suppressed. Accordingly, a heat generation due to an increase in torque is suppressed, and a temperature rise of the kneaded product is then suppressed. Accordingly, the volatilization and decomposition of the anti-aging agent comprised in the first composition are suppressed.

In the present disclosure, the term of “(meth)acrylic resin” means a polymer (homopolymer or copolymer) comprising a structural unit derived from a compound having (meth)acryloyl group.

The compound having (meth)acryloyl group is for example, (meth)acrylic acid ester and (meth)acryl amide. Particularly, the compound having (meth)acryloyl group is preferably (meth)acrylic acid ester. That is, the (meth)acrylic resin is preferably a polymer comprising a structural unit derived from (meth)acrylic acid ester. The structural unit derived from (meth)acrylic acid ester comprised in the (meth)acrylic resin may be only one species thereof, or two or more species thereof.

The (meth)acrylic acid ester is for example, methyl (meth)acrylate, ethyl (meth)acrylate, propyl (meth)acrylate, n-butyl (meth)acrylate, hexyl (meth)acrylate, 2-ethyl hexyl (meth)acrylate, tert-octyl (meth)acrylate, isoamyl (meth)acrylate, decyl (meth)acrylate, isodecyl (meth)acrylate, lauryl (meth)acrylate, stearyl (meth)acrylate, isostearyl (meth)acrylate, cyclohexyl (meth)acrylate, 4-n-butyl cyclohexyl (meth)acrylate, 4-tert-butyl cyclohexyl (meth)acrylate, bornyl (meth)acrylate, isobornyl (meth)acrylate, 2-ethyl hexyl diglycol (meth)acrylate, butoxyethyl (meth)acrylate, 2-chloroethyl (meth)acrylate, 4-bromobutyl (meth)acrylate, cyanoethyl (meth)acrylate, benzyl (meth)acrylate, butoxymethyl (meth)acrylate, 3-methoxybutyl (meth)acrylate, 2-(2-methoxyethoxy)ethyl (meth)acrylate, 2-(2-butoxyethoxy)ethyl (meth)acrylate, 2,2,2-tetrafluoroethyl (meth)acrylate, 1H,1H,2H,2H-perfluorodecyl (meth)acrylate, 4-butylphenyl (meth)acrylate, phenyl (meth)acrylate, 2,4,5-tetramethylphenyl (meth)acrylate, 4-chlorophenyl (meth)acrylate, 2-phenoxymethyl (meth)acrylate, 2-phenoxyethyl (meth)acrylate, glycidyl (meth)acrylate, glycidyloxybutyl (meth)acrylate, glycidyloxyethyl (meth)acrylate, glycidyloxypropyl (meth)acrylate, tetrahydrofurfuryl (meth)acrylate, 2-hydroxyethyl (meth)acrylate, 3-hydroxypropyl (meth)acrylate, 2-hydroxypropyl (meth)acrylate, 2-hydroxybutyl (meth)acrylate, 3-hydroxybutyl (meth)acrylate, 4-hydroxybutyl (meth)acrylate, cyclic trimethylolpropane formal (meth)acrylate, phenyl glycidyl ether (meth)acrylate, dimethylaminoethyl (meth)acrylate, diethylaminoethyl (meth)acrylate, dimethylaminopropyl (meth)acrylate, diethylaminopropyl (meth)acrylate, trimethoxysilylpropyl (meth)acrylate, trimethylsilylpropyl (meth)acrylate, polyethylene oxide monomethyl ether (meth)acrylate, polyethylene oxide (meth)acrylate, polyethylene oxide monoalkyl ether (meth)acrylate, dipropylene glycol (meth)acrylate, polypropylene oxide monoalkyl ether (meth)acrylate, 2-methacryloyloxyethyl succinic acid, 2-methacryloyloxy hexahydrophthalic acid, 2-methacryloyloxy ethyl-2-hydroxypropyl phthalate, ethoxy diethylene glycol (meth)acrylate, butoxy diethylene glycol (meth)acrylate, trifluoroethyl (meth)acrylate, perfluorooctyl ethyl (meth)acrylate, 2-hydroxy-3-phenoxypropyl (meth)acrylate, ethylene oxide (EO; hereinafter, the same is applied) modified phenol (meth)acrylate, EO modified cresol (meth)acrylate, EO modified nonylphenol (meth)acrylate, propyleneoxide (PO; hereinafter, the same is applied) modified nonylphenol (meth)acrylate, EO modified-2-ethyl hexyl (meth)acrylate, dicyclopentenyl (meth)acrylate, dicyclopentenyloxy ethyl (meth)acrylate, dicyclopentanyl (meth)acrylate, (3-ethyl 3-ocetanylmethyl) (meth)acrylate, phenoxyethylene glycol (meth)acrylate, 2-carboxyethyl (meth)acrylate, and 2-(meth)acryloyloxyethyl succinate.

Particularly, from the viewpoint of suppressing the excessive increase in torque during kneading, the (meth)acrylic acid ester is preferably (meth)acrylic acid alkyl ester, more preferably (meth)acrylic acid alkyl ester having alkyl group of 1 to 4 carbon atoms, and further preferably methyl (meth)acrylate.

The (meth)acryl amide is for example, (meth)acryl amide, N-methyl (meth)acryl amide, N-ethyl (meth)acryl amide, N-propyl (meth)acryl amide, N-n-butyl (meth)acryl amide, N-t-butyl (meth)acryl amide, N-butoxymethyl (meth)acryl amide, N-isopropyl (meth)acryl amide, N-methylol(meth)acryl amide, N,N-dimethyl (meth)acryl amide, N,N-diethyl (meth)acryl amide, and (meth)acryloyl morpholine.

The (meth)acrylic resin is preferably a copolymer comprising the structural unit derived from a compound having (meth)acryloyl group, and the structural unit derived from any other ethylene-based unsaturated monomer other than those having compound having (meth)acryloyl group.

The other ethylene-based unsaturated monomer may be a monofunctional ethylene-based unsaturated monomer having one ethylene-based unsaturated group, or a multifunctional ethylene-based unsaturated monomer having two or more ethylene-based unsaturated groups.

The monofunctional ethylene-based unsaturated monomer is for example, α-olefin, monofunctional aromatic vinyl compound, monofunctional vinyl ether, N-vinyl compound, unsaturated carboxylic anhydride, N-substituted maleimide, and (meth)acrylonitrile.

The α-olefin is for example, ethylene, propylene, 1-butene, 1-pentene, 1-hexene, 1-heptene, 1-octene, 1-decene, 4-methyl-1-pentene, and 4-methyl-1-hexene.

The monofunctional aromatic vinyl compound is for example, stylene, dimethylstylene, trimethylstylene, isopropylstylene, chloromethylstylene, methoxystylene, acetoxystylene, chlorostylene, dichlorostylene, bromostylene, vinyl benzoate methyl ester, 3-methylstylene, 4-methylstylene, 3-ethylstylene, 4-ethylstylene, 3-propylstylene, 4-propylstylene, 3-butylstylene, 4-butylstylene, 3-hexylstylene, 4-hexylstylene, 3-octylstylene, 4-octylstylene, 3-(2-ethylhexyl)stylene, 4-(2-ethylhexyl)stylene, allylstylene, isopropenylstylene, butenylstylene, octenylstylene, 4-t-butoxycarbonylstylene, and 4-t-butoxystylene.

The monofunctional vinyl ether is for example, methyl vinyl ether, ethyl vinyl ether, propyl vinyl ether, n-butyl vinyl ether, t-butyl vinyl ether, 2-ethyl hexyl vinyl ether, n-nonyl vinyl ether, lauryl vinyl ether, cyclohexyl vinyl ether, cyclohexyl methyl vinyl ether, 4-methyl cyclohexyl methyl vinyl ether, benzyl vinyl ether, dicyclopentenyl vinyl ether, 2-dicyclopentenoxy ethyl vinyl ether, methoxyethyl vinyl ether, ethoxyethyl vinyl ether, butoxyethyl vinyl ether, methoxyethoxy ethyl vinyl ether, ethoxyethoxy ethyl vinylether, methoxypolyethylene glycol vinyl ether, tetrahydrofurfuryl vinyl ether, 2-hydroxyethyl vinyl ether, 2-hydroxypropyl vinyl ether, 4-hydroxybutyl vinyl ether, 4-hydroxymethyl cyclohexyl methyl vinyl ether, diethylene glycolmonovinyl ether, polyethylene glycol vinyl ether, chlorethyl vinyl ether, chlorbutyl vinyl ether, chlorethoxyethyl vinyl ether, phenyl ethyl vinyl ether, and phenoxypolyethylene glycol vinyl ether.

The monofunctional N-vinyl compound is for example, N-vinyl ε-caprolactam and N-vinylpyrrolidone.

The unsaturated carboxylic anhydride is for example, maleic anhydride and itaconic anhydride.

The N-substituted maleimide is for example, N-methylmaleimide, N-ethylmaleimide, N-n-propylmaleimide, N-i-propylmaleimide, N-n-butylmaleimide, N-t-butylmaleimide, N-n-hexylmaleimide, N-cyclopentylmaleimide, N-cyclohexylmaleimide, N-phenylmaleimide, and N-1-naphthylmaleimide.

The multifunctional ethylene-based unsaturated monomer is for example, multifunctional (meth)acrylic acid ester, unsaturated carboxylic acid allyl ester, multi-base acid allyl ester, multifunctional aromatic vinyl compound, and multifunctional vinyl ether.

The multifunctional (meth)acrylic acid ester is for example, ethylene glycol di(meth)acrylate, diethylene glycol di(meth)acrylate, triethylene glycol di(meth)acrylate, polyethylene glycol di(meth)acrylate, propylene glycol di(meth)acrylate, dipropylene glycol di(meth)acrylate, tripropylene glycol di(meth)acrylate, polypropylene glycol di(meth)acrylate, butylene glycol di(meth)acrylate, tetraethylene glycol di(meth)acrylate, neopentyl glycol di(meth)acrylate, 3-methyl 1,5-pentanediol di(meth)acrylate, hexanediol di(meth)acrylate, heptanediol di(meth)acrylate, EO modified neopentyl glycol di(meth)acrylate, PO modified neopentyl glycol di(meth)acrylate, EO modified hexanediol di(meth)acrylate, PO modified hexanediol di(meth)acrylate, octanediol di(meth)acrylate, nonanediol di(meth)acrylate, decanediol di(meth)acrylate, dodecanediol di(meth)acrylate, 1,6-hexanediol di(meth)acrylate, glycerin di(meth)acrylate, pentaerythritol di(meth)acrylate, ethylene glycol diglycidyl ether di(meth)acrylate, diethylene glycol diglycidyl ether di(meth)acrylate, tricyclodecane dimethanol di(meth)acrylate, trimethylolethane tri(meth)acrylate, trimethylolpropane tri(meth)acrylate, trimethylolpropane EO additive tri(meth)acrylate, pentaerythritol tri(meth)acrylate, pentaerythritol tetra(meth)acrylate, dipentaerythritol tetra(meth)acrylate, dipentaerythritol penta (meth)acrylate, dipentaerythritol hexa (meth)acrylate, tri(meth)acryloyloxy ethoxytrimethylolpropane, glycerinpoly glycidyl ether poly(meth)acrylate, and tris(2-acrylolyl)xyethyl)isocyanurate.

The unsaturated carboxylic acid allyl ester is for example, allyl (meth)acrylate and allyl cinnamate.

The multi-base acid allyl ester is for example, diallyl phtalate, diallyl maleate, triallyl cyanurate, and triallyl isocyanurate.

The multifunctional aromatic vinyl compound is for example, divinylbenzene, 1,3-divinylnaphthalene, and 1,5-divinylnaphthalene.

The multifunctional vinyl ether is for example, 1,4-butanediol divinyl ether, ethylene glycol divinyl ether, diethylene glycol divinyl ether, triethylene glycol divinyl ether, polyethylene glycol divinyl ether, propyleneglycol divinyl ether, butylene glycol divinyl ether, hexanediol divinyl ether, 1,4-cyclohexanedimethanol divinyl ether, bisphenol A alkyleneoxide divinyl ether, bisphenol F alkyleneoxide divinyl ether, trimethylolethane trivinyl ether, trimethylolpropane trivinyl ether, ditrimethylolpropane tetravinyl ether, glycerin trivinyl ether, pentaerythritol tetravinyl ether, dipentaerythritol pentavinyl ether, dipentaerythritol hexavinyl ether, EO additive trimethylolpropane trivinyl ether, PO additive trimethylolpropane trivinyl ether, EO additive ditrimethylolpropane tetravinyl ether, PO additive ditrimethylolpropane tetravinyl ether, EO additive pentaerythritol tetravinyl ether, PO additive pentaerythritol tetravinyl ether, EO additive dipentaerythritol hexavinyl ether, and PO additive dipentaerythritol hexavinyl ether.

Particularly, from the viewpoint of making a copolymer that can be melted and kneaded at low temperature and has excellent flexibility, the other ethylene-based unsaturated monomer is preferably α-olefin, more preferably α-olefin having 2 to 10 carbon atoms, and particularly preferably ethylene.

That is, the (meth)acrylic resin preferably comprises the structural unit derived from (meth)acrylic acid ester and the structural unit derived from α-olefin, more preferably the structural unit derived from (meth)acrylic acid alkyl ester and the structural unit derived from α-olefin, further preferably the structural unit derived from (meth)acrylic acid alkyl ester having alkyl group of 1 to 4 carbon atoms and a structural unit derived from α-olefin, and particularly preferably the structural unit derived from methyl (meth)acrylate and the structural unit derived from α-olefin.

Also, the (meth)acrylic resin comprises preferably the structural unit derived from (meth)acrylic acid ester and the structural unit derived from ethylene, more preferably the structural unit derived from (meth)acrylic acid alkyl ester and the structural unit derived from ethylene, further preferably the structural unit derived from (meth)acrylic acid alkyl ester having alkyl group of 1 to 4 carbon atoms and the structural unit derived from ethylene, and particularly preferably the structural unit derived from methyl (meth)acrylate and the structural unit derived from ethylene.

In the copolymer comprising the structural unit derived from (meth)acrylic acid ester and the structural unit derived from α-olefin, the amount of the structural unit derived from (meth)acrylic acid ester is, from the viewpoint of obtaining an appropriate melting temperature, preferably 5% by mass to 50% by mass, more preferably 10% by mass to 45% by mass, further preferably 15% by mass to 40% by mass, particularly preferably 20% by mass to 40% by mass, further particularly preferably 25% by mass to 40% by mass, highly preferably 30% by mass to 40% by mass, and the most preferably 35% by mass to 40% by mass, relative to the total amount of the (meth)acrylic resin.

In the case where the amount of the structural unit derived from (meth)acrylic acid ester is within the above ranges, the copolymer can be melted and kneaded at low temperature and has excellent flexibility.

In the copolymer comprising the structural unit derived from (meth)acrylic acid ester and the structural unit derived from α-olefin, the amount of the structural unit derived from α-olefin is preferably 50% by mass to 95% by mass, more preferably 50% by mass to 95% by mass, more preferably 55% by mass to 90% by mass, further preferably 60% by mass to 85% by mass, particularly preferably 60% by mass to 80% by mass, further particularly preferably 60% by mass to 75% by mass, highly preferably 60% by mass to 70% by mass, and the most preferably 60% by mass to 65% by mass, relative to the total amount of the (meth)acrylic resin.

### —MFR—

The melt flow rate (MFR) of (meth)acrylic resin is, from the viewpoint of fluidity and stickiness, as well as the suppression of fisheye formation and the improvement of appearance when it is made into a film, preferably 0.01 g/10 min. or more, more preferably 0.1 g/10 min. or more, further preferably 1 g/10 min. or more, and particularly preferably 10 g/10 min. or more. Also, from the viewpoint of increasing the strength of the film, the MFR thereof is preferably less than 1000 g/10 min, more preferably less than 100 g/10 min., and further preferably less than 50 g/10 min.

In the present disclosure, the melt flow rate (MFR) is measured at a temperature of 190° C. and a load of 21.18 N in accordance with JIS K7210-1:2014 (ISO 1133-1:2011).

### —Melting Temperature

The (meth)acrylic resin is, from the viewpoint of a productivity when it is produced by melting and kneading, preferably a thermoplastic resin.

In the present disclosure, the thermoplastic resin means a resin with a melting temperature of 150° C. or less.

The melting temperature of (meth)acrylic resin is, from the viewpoint of suppressing the rise in resin temperature during processing and preventing loss of anti-aging agent during processing, preferably 0° C. to 150° C., more preferably 10° C. to 120° C., further preferably 15° C. to 100° C., particularly preferably 20° C. to 80° C., more particularly preferably 20° C. to 65° C., highly preferably 30° C. to 60° C., and the most preferably 40° C. to 60° C.

In the present disclosure, the melting temperature is measured in accordance with JIS K7121:2012 (ISO 3146:1985).

### —Bending Modulus—

The bending modulus of (meth)acrylic resin is, from the viewpoint of easiness of keeping the shape of the composition, preferably 0.001 MPa to 4000 MPa, more preferably 0.001 MPa to 2500 MPa, further preferably 0.01 MPa to 500 MPa, particularly preferably 0.01 MPa to 100 MPa, highly preferably 0.01 MPa to 20 MPa, more highly preferably 0.01 MPa to 15 MPa, particularly highly preferably 0.1 MPa to 10 MPa, and the most preferably 1 MPa to 5 MPa.

In the present disclosure, the bending modulus is measured in accordance with ASTM D747-70.

### —Durometer Hardness—

The durometer hardness of (meth)acrylic resin is, from the viewpoint of easiness of keeping the shape of the composition, preferably 1 to 70, more preferably 1 to 40, further preferably 2 to 35, particularly preferably 3 to 30, highly preferably 3 to 25, and the most preferably 5 to 20.

In the present disclosure, the durometer D hardness is measured in accordance with JIS K7215-1986.

### —Weight-Average Molecular Weight—

The weight-average molecular weight of (meth)acrylic resin is, from the viewpoint of suppressing the excessive increase in torque during kneading, preferably 5000 to one million, more preferably ten thousand to a half million, further preferably thirty thousand to four hundred thousand, particularly preferably thirty thousand to three hundred thousand, highly preferably thirty thousand to fifteen thousand, more particularly preferably thirty thousand to seventy thousand, and the most preferably thirty thousand to fifty thousand.

In the present disclosure, the weight-average molecular weight is measured using gel permeation chromatography (GPC) For example, HLC-8121GPC/HT (manufactured by TOSOH Corp.) is used as GPC, GMHHR-H(S) HT (× three) (manufactured by TOSOH Corp.) is used as column, orthodichlorobenzene (BHT 0.5 mg/mL is added) is used as an eluent. The conditions are 2 mg/mL for the sample concentration, 1 mL/min for the flow rate, 0.3 mL for the sample injection volume, and 155° C. for the measurement temperature, and is detected using a differential refractive index (RI) detector.

### —Glass Transition Temperature—

The (meth)acrylic resin preferably has motility of the resin molecular chains in the usage environment from the viewpoint of ensuring the motility of anti-aging agent in the composition. Since the motility of the molecular chains in the resin is severely restricted under the environment below the glass transition temperature, the glass transition temperature of (meth)acrylic resin is preferably 40° C. or less, more preferably 25° C. or less, further preferably 10° C. or less, particularly preferably −10° C. or less, further particularly preferably −20° C. or less, and the most preferably −30° C. or less. The lower limit of the glass transition temperature is not particularly limited, and is for example, −150° C.

In the present disclosure, the glass transition temperature is measured in accordance with JIS K7121: 2012 (ISO 3146: 1985).

The amount of (meth)acrylic resin is preferably 10% by mass to 90% by mass relative to total amounts of the first composition of the present disclosure. When the amount of (meth)acrylic resin is 10% by mass or more, it is easy to retain anti-aging agent and porous material in the composition. Also, when the amount of (meth)acrylic resin is 90% by mass or less, the amount of anti-aging agent and porous material is ensured to a certain extent, and the effect of keeping the plant fresh is high. From the viewpoint of exhibiting the effect of keeping the freshness of plant and easiness of increasing the shape retention, the amount of (meth)acrylic resin is more preferably 15% by mass or more relative to total amounts of the first composition of the present disclosure, further preferably 20% by mass or more, and particularly preferably 25% by mass or more. On the other hand, from the viewpoint of more exhibiting the effect of keeping the freshness of plant, the amount of (meth)acrylic resin is more preferably 85% by mass or less relative to total amounts of the first composition of the present disclosure, further preferably 75% by mass or less, particularly 60% by mass or less, further particularly preferably 50% by mass or less, and the most preferably 40% by mass or less.

### (Anti-Aging Agent)

The first composition of the present disclosure comprises anti-aging agent. The anti-aging agent comprised in the first composition of the present disclosure may be only one species thereof, or may be two or more species thereof.

In the present disclosure, the anti-aging agent means a substance that inhibits the aging or the deterioration of greenfrocery and plant such as grasses and flowers, etc. The aging or deterioration of a plant can be confirmed, for example, by changes in plant over time (for example, changes in color, hardness).

Since the first composition of the present disclosure comprises the anti-aging agent, the freshness of the plant is kept. Specifically, the anti-aging agent can suppress the change in color of the plant or delay the change in color etc., of the plant.

The anti-aging agent is for example, an inhibitor of ethylene biosynthesis that is an aging hormone of plant, and an inhibitor of the action of ethylene.

The inhibitor of ethylene biosynthesis is for example, an inhibitor of ethylene biosynthesis that inhibits the conversion of S-adenosyl-L-methionine to 1-aminocyclopropane 1-carboxylic acid (ACC); the inhibitor of ethylene biosynthesis that inhibits the conversion of ACC to ethylene said inhibitor being cobalt salts or nickel salts as plant-available form; radical scavengers of phenols; polyamines; structural analogues of ACC; salicylic acid; acibenzolar S-methyl; structural analogues of ascorbic acid; and triazolyl compound.

The inhibitor of ethylene biosynthesis that inhibits the conversion of S-adenosyl-L-methionine to ACC is for example, vinyl glycine derivatives, hydroxylamine, and oxime eher derivatives.

The radical scavengers of phenols are for example, n-propyl gallate.

The polyamines are for example, putrescine, spermine, and spermidine.

The structural analogues of ACC are for example, α-aminoisobutylic acid, and L-aminocyclopropene 1-carboxylic acid.

The struxtural analogues of ascorbic acid are for example, prohexadione calcium salt and Trinexapac-ethyl.

The triazole compound is for example, paclobutrazol and Uniconazole.

The inhibitor of the action of ethylene is for example, the structural analogues of ethylene, 3-amino-1,2,4-triazole, and silver salts (for example, silver salts of thiosulfate).

The structural analogues of ethylene are for example, cyclopropene compound and 2,5-norbornadiene. [0069]

The anti-aging agent may be a plant hormone such as gibberellin, cytokinin, and abscisic acid.

Particularly, from the viewpoint of stability of the composition, the anti-aging agent is not preferably decomposed or modified under the temperature of 90° C. or less.

Also, from the viewpoint of easiness of obtaining the effect of keeping the freshness of plant, the anti-aging agent is preferably a form of a liquid or a gas under a condition of normal temperature (25° C.) and a normal pressure (1 atm).

When the anti-aging agent is a form of gas under a condition of normal temperature and normal pressure (1 atm), in order to suppress the volatilization thereof from the composition, the anti-aging agent is preferably included in a molecular inclusion agent and is used as an inclusion complex.

Particularly, from the viewpoint of more easiness of exhibiting the effect of keeping the freshness of plant, the anti-aging agent is preferably a structural analogue to ethylene, and more preferably a cyclopropene compound.

Since the structural anlogue to ethylene has a similar structure to ethylene, it is considered that it has a superior action on inhibiting the reception of ethylene by plant, and as a result, it can suppress the deterioration on plant.

The cyclopropene compound is for example, the compound represented by the formula (1) below.

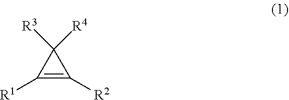

In formula (1), R¹, R², R³, and R⁴ represents each independently a hydrogen atom, or a hydrocarbon atom.

The hydrocarbon group which is represented by R¹, R², R³, and R⁴ is for example, an aliphatic hydrocarbon group and an aromatic hydrocarbon group. The hydrocarbon group is preferably an aliphatic hydrocarbon group, more preferably a straight-chain alkyl group, further preferably a straight-chain alkyl group having 1 to 4 of carbon atoms, and particularly preferably a methyl group.

The hydrocarbon atom may have substituent(s). The substituents are for example, a halogen atom, a nitro group, an alkoxy group, a substituted or nonsubstituted phenyl group, and a cyano group.

Particularly, R¹ represents preferably a hydrocarbon group, and R², R³, and R⁴ represent preferably a hydrogen atom.

The cyclopropene compound is specifically for example, 1-methylcyclopropene.

The cyclopropene compound is preferably comprised as the inclusion complex that is included by any molecular inclusion agents in the first composition of the present disclosure.

The molecular inclusion agent may be an organic molecular inclusion agent, or an inorganic molecular inclusion agent.

The organic molecular inclusion agent is for example, cyclodextrin, substituted cyclodextrin, and crown ether. The inorganic molecular inclusion agent is for example, zeolite.

Particularly, the molecular inclusion agent is preferably the organic molecular inclusion agent, more preferably α-cyclodextrin, β-cyclodextrin, γ-cyclodextrin, or mixtures of these compounds, and further preferably α-cyclodextrin.

In the inclusion complex consisting of the anti-aging agents and the molecular inclusion agent, the amount of the anti-aging agent is preferably 0.5% by mass to 50% by mass, more preferably 1% by mass to 25% by mass, further preferably 1% by mass to 10% by mass, and particularly preferably 2% by mass to 5% by mass, relative to the total amounts of the inclusion complex.

From the viewpoint of increasing the effect of keeping the freshness of plant and the easiness of increasing the shape-keeping property, the amount of the anti-aging agent is preferably 0.01% by mass to 10% by mass, more preferably 0.02% by mass to 5% by mass, further preferably 0.05% by mass to 2% by mass, and particularly preferably 0.1% by mass to 1% by mass, relative to total amounts of the first composition of the present disclosure.

The amount of the inclusion complex consisting of the anti-aging agent and the molecular inclusion agent is preferably 0.1 parts by mass to 100 parts by mass, more preferably 1 part by mass to 80 parts by mass, further preferably 2 parts by mass to 50 parts by mass, and particularly preferably 3 parts by mass to 30 parts by mass, relative to 100 parts by mass of (meth)acrylic resin.

### (Porous Material)

The first composition of the present disclosure comprises a porous material. The porous material comprised in the first composition of the present disclosure may be only species thereof, or may be two or more species thereof.

In the present disclosure, the porous material means a material having a plural of voids or pores.

Since the first composition of the present disclosure comprises a porous material, it can release the anti-aging agent in a sustained manner through the porous material. By the sustained release of the anti-aging agent, the effect of keeping the freshness of plant by the anti-aging agent can be exhibited.

The type of the porous material is not particularly limited, the porous material is for example, ceramics, metals, carbon materials, organic materials, and composite thereof.

The porous material is preferably water-insoluble.

The average pore diameter of the porous material is, from the viewpoint of the sustained release of the anti-aging agent, preferably 1 nm to 100 μm, more preferably 1 nm to 10 μm, further preferably 2 nm to 1 μm, particularly 2 nm to 500 nm, further particularly 2 nm to 50 nm, and the most preferably 10 nm to 50 nm.

In the present disclosure, the average pore diameter of the porous material is measured by the methods such as a gas absorption method, a mercury intrusion method, and an image processing method. For example, in the gas absorption method, measurement is carried out using BELSORP-miniX (manufatured by MicrotracBEL Corporation).

The moisture amount of the porous material is preferably 10% or less, more preferably 5% or less, and further preferably 1% or less.

In the present disclosure, the moisture amount of the porous material is measured by a bone-dry method using the weights of 50% RH at 23° C. and the weights after drying at 105° C. (dry weights).

The average particle diameter of porous material is preferably 10 nm to 1 mm, more preferably 100 nm to 100 μm, and further preferably 1 μm to 50 μm.

In the present disclosure, the average particle diameter of porous material is measured by the method such as a dynamic light scattering method, a laser diffraction method, and an image processing method depending on the particle dimeter. For example, in the image processing method, an equivalent circle diameter is calculated from the image observed under microscope. In the present specification, the average particle diameter represents the average porous diameter of the porous material comprised in the composition, and may be sometimes different from the average particle diameter of the porous material used as raw materials.

It is considered that as the oil absorption amount of the porous materials is higher, the voids ratio is higher. From the viewpoint of increasing the permeability of the anti-aging agent, the oil absorption amount of porous material is preferably 1 mL/100 g to 250 mL/100 g, more preferably 10 mL/100 g to 200 mL/100 g, and further preferably 50 mL/100 g to 150 mL/100 g.

Specifically, the porous material is for example, silica gel, activated carbon, mesoporous silica, zeolite, metallic porous body, metal organic framework, ceramics, diatomaceous earth, and resin porous body. The porous material is preferably an inorganic porous material, more preferably an inorganic porous materials comprising silicon, further preferably diatomaceous earth, and particularly preferably calcined diatomaceous earth.

From the viewpoint of increasing the effect of keeping the freshness of plant and easeness of increasing the shape-keeping property, the amount of the porous material is preferably 1% by mass to 90% by mass, more preferably 5% by mass to 70% by mass, further preferably 10% by mass to 60% by mass, particularly preferably 20% by mass to 60% by mass, further particularly preferably 25% by mass to 60% by mass, and the most preferably 30% by mass to 45% by mass, relative to total amounts of the first composition of the present disclosure.

The amount of the porous material is preferably 1 part by mass to 300 parts by mass, more preferably 10 parts by mass to 200 parts by mass, further preferably 20 parts by mass to 150 parts by mass, particularly preferably 50 parts by weight to 150 parts by weight, and the most preferably 110 parts by weight to 150 parts by weight, relative to 100 parts by mass of (meth)acrylic resin.

### (Other Ingredients)

The first composition of the present disclosure may comprise other ingredients other than (meth)acrylic resin, anti-aging agent, and porous material.

The other ingredients are for example, known additives such as any resins other than (meth)acrylic resin, a plasticizer, an antioxidant, a neutralizer, a cross-linker, a heat stabilizer, a weathering agent, a pigment, a filler, a lubricant, and a flame retardant.

The other ingredients comprised in the first composition of the present disclosure may be only one species thereof, or may be two or more species thereof.

The amount of the other ingredients may be set depending on the use purpose, and is not particularly limited, and is preferably less than 50% by mass, more preferably less than 40% by mass, and further preferably less tan 30% by mass, relative to total amounts of the first composition of the present disclosure.

From the viewpoint of further suppressing the excessive increase in torque during kneading, the first composition of the present disclosure comprises preferably a plasticizer.

The amount of a plasticizer is, from the viewpoint of more increasing the dimentional stability of the composition, preferably 60% by mass or less, more preferably 50% by mass or less, further preferably 30% by mass or less, particularly preferably 25% by mass or less, and the most preferably 20% by mass or less, relative to total amounts of the first composition of the present disclosure.

The type of the plasticizer is not particularly limited, from the viewpoint of suppressing the volatilization of the plasticizer from the compound, the saturated vapor pressure of the plasticizer at 25° C. and under 1 air pressure is, preferably 1.0×10⁻⁴, and more preferably 1.0×10⁻⁵.

The HSP length between the (meth)acrylic resin and the plasticizer is, from the viewpoint of keeping the plastixcizer stabily by the composition and the easiness of suppressing the bleed, preferably 7.0 MPa^{1/2} or less, more preferably 5.0 MPa^{1/2} or less, further preferably 4.0 MPa^{1/2} or less, particularly preferably 3.0 MPa^{1/2} or less, and the most preferably 2.5 MPa^{1/2} or less.

As the HSP length between the (meth)acrylic resin and the plasticizer is more approaching 0, it is said that the the compatibility of the (meth)acrylic resin and the plasticizer is better.

In the present specification, the HSP length R between the (meth)acrylic resin and the plasticizer is calculated by the following equation.

$$R = {\{ {( δ pA - δ pB )}^{2} \div {( δ hA - δ hB )}^{2} \}}^{1 / 2}$$

In the equation, δpA represents a polar term in Hansen solubility parameters of (meth)acrylic resin, and δpB represents a polar term in Hansen solubility parameters of plasticizer, δhA represents a hydrogen-bond term in Hansen solubility parameters of (meth)acrylic resin, and δhB represents a hydrogen-bond term in Hansen solubility parameters of plasticizer.

In the Hansen solubility parameters, the solubility of a substance is divided into three components (dispersion term δd, polarity term δp, hydrogen bond term δh) and is expressed in three-dimensional space. The dispersion term δd represents an effect of dispersion force, the polarity term op represents an effect of a dipole force, and the hydrogen bond term δh represents an effect of a hydrogen bond force. The definition and calculation of Hansen solubility parameters is described in Charles M. Hansen, Hansen Solubility Parameters: A Users Hand book (CRC press, 2007). Also, even when the literature values for substances are not known, Hansen solubility parameters can be easily estimated from the chemical structure of the substance using a computer software Hansen Solubility Parameters in Practice (HSPiP). In the present invention, for the compounds and the monomers that are registered in the database included in HSPiP version 4.1, the values are used, and for the compounds and the monomers that are not registered in the database, δd, δp, δh are determined using the estimated values obtained from HSPiP version 4.1.

The δp or δh of the (meth)acrylic resin is calculated as a combined value of a value that is obtained by multiplying the δp or δh of each monomer derived from each structural unit that is comprised in the (meth)acrylic resin by the content rate of each structural unit.

When the (meth)acrylic resin or the plasticizer is a mixture of two or more substances, the values are obtained by multiplying the δp of each substance comprised in the mixture by the content rate of each substance and then are combined to make the δp of the mixture.

When (meth)acrylic resin or a plasticizer is a mixture of two or more substances, the values are obtained by multiplying the δh of each substance comprised in the mixture by the content rate of each substance and then are combined to make the δp of the mixture.

The plasticizer is for example, phosphate ester, fatty acid ester, acetylcitrate ester, glycolate ester, trimellitate ester, phtalate and its enantiomeric ester, ricinoleate ester, epoxidized oil, as well as chlorinated paraffin. The plasticizer is, from the viewpoint of the compatibility with (meth)acrylic resin, preferably fatty acid ester, acetylcitrate ester, phthalate ester, isophthalate ester, or terephthalate ester, more preferably adipate ester, sebacate ester, acetylcitrate ester, or phthalate ester, further preferably adipate ester, sebacate ester, or acetylcitrate ester, and particularly preferably acetylcitrate ester.

The acetylcitrate ester is for example, triethyl acetylcitrate, tributyl acetylcitrate, and 2-ethylhexyl acetylcitrate. Particularly, the acetylcitrate ester is preferably tributyl acetylcitrate.

The viscosity at 150° C. of the first composition of the present disclosure is, from the viewpoint of suppressing the excessive increase in torque during kneading, preferably 100 Pa·s to 10000 Pa·s, and more preferably 1000 Pa·s to 6000 Pa·s.

In the present disclosure, the viscosity at 150° C. of a resin composition is measured using a capillary rheometer in accordance with JIS K7199 at a measurement temperature of 150° C., a shear rate of 30 sec-1, and an orifice size of 2 mm inner diameter and 20 mm length. As the capillary rheometer, for example, Capillograph 1D (manufactured by Toyo Seiki Seisaku-sho, Ltd) is used.

The method for producing the first composition of the present disclosure is not particularly limited, and is for example, a method of mixing a (meth)acrylic resin, an anti-aging agent, a porous material, and other ingredients as necessary, using a mixer such as a Banbury mixer, a super mixer, a kneader, an extruder, a planetary mixer, a butterfly mixer, a dissolver, a roll mill, and a mixing pot. After mixing, the composition may be formed into a powder, a pellet, a block, or the others. A masterbatch in which some of the raw materials of (meth)acrylic resin, anti-aging agent, and porous material are premixed may be used.

Also, some of raw materials such as the (meth)acrylic resin, the anti-aging agent and the porous material (for example, acryl resin) are premoded into a powder, a pellet, a sheet, a lump, and the others, and the obtained molded product may be contacted with the remaining raw materials (for example, the anti-aging agent and the porous material) so that the molded product impregnates or absorbs the remaining raw materials to produce a composition.

For example, when the first composition of the present disclosure comprises two or more types of (meth)acrylic resin, the (meth)acrylic resin, the anti-aging agent, and the porous material may be mixed at once, or one type of the (meth)acrylic resin, the anti-aging agent, and the porous material may be mixed, and then the obtained mixture is mixed with the remaining ingredients to produce a composition.

### <Second Composition>

The second composition of the present disclosure comprises a thermoplastic resin, an anti-aging agent, a porous material, and a plasticizer.

### (Thermoplastic Resin)

A second composition of the present disclosure comprises a thermoplastic resin. The thermoplastic resins comprised in the second composition of the present disclosure may be one species thereof, or may be two or more species thereof.

The thermoplastic resin is for example, polyolefins such as polyethylene and polypropylene; meth (acryl) resins such as methyl poly(meth)acrylate; polyvinyl acetate; polyvinyl chloride; polystylene; acrylonitrile/butadiene/stylenecopolymer; acrylonitrile/stylene copolymer; plastic elastomers; stylene thermoplastic elastomers, urethane thermoplastic elastomers; polyvinyl alcohol; polyethylene glycol; polyesters such as polyethylene telephthalate; polycarbonates; and natural resins.

Particularly, from the viewpoint of providing the mobility of molecular chains in the resin in the usage environment, the thermoplastic resin is preferably polyolefin, (meth)acrylic resin, polyvinyl acetate, polyvinyl chloride, olefinic thermoplastic elastomer, stylene thermoplastic elastomer, and urethane thermoplastic elastomer.

The polyolefins are for example, a high-density polyethylene, a linear low-density polyethylene, a high-pressure low-density polyethylene, polypropylene, α-olefin copolymer, and copolymers of ethylene and other polymerizable monomers having vinyl group.

Particularly, the polyolefin is preferably a linear low-density polyethylene, a high-pressure low-density polyethylene, polypropylene, α-olefin copolymer, or a copolymer of ethylene and vinyl monomer.

The α-olefin copolymer is a copolymer with a structural unit derived from α-olefin. The α-olefin is specifically for example, as described above.

The α-olefin is preferably α-olefin having 2 to 8 carbon atoms, and more preferably ethylene, propylene, 1-butene, 1-hexene, or 1-octene.

The α-olefin copolymer is for example, ethylene·α-olefin copolymer, propylene·α-olefin copolymer, ethylene·propylene·α-olefin·copolymer, and copolymers with only a structural unit derived from α-olefin having 4 or more carbon atoms.

In a copolymer of ethylene and vinyl monomer, the vinyl monomer is not particularly limited as long as it is a polymerizable monomer having a vinyl group. The vinyl monomers are for example, vinyl acetate, (meth)acrylate, (meth)acrylic acid ester, vinyl alcohol, vinyl chloride, maleic anhydride, and tetrafluoroethylene.

Particularly, a copolymer of ethylene and vinyl monomer is preferably a copolymer of ethylene and vinyl monomer having an oxygen atom. The vinyl monomers having an oxygen atom are for example, ethylene-vinyl acetate copolymer, a copolymer of ethylene and organic carboxylic acid derivatives having ethylenically unsaturated bonds (for example, ethylene(meth)acrylic acid ester copolymer (such as ethylene-methyl acrylatecopolymer and/or ethylene-methyl methacrylate copolymer), and ethylene-vinyl alcohol copolymer. The copolymer of ethylene and vinyl monomer is more preferably an ethylene-vinyl acetate copolymer, or an ethylene (meth)acrylic acid ester copolymer.

Here, among the above-mentioned thermoplastic resins, a polymer comprising the structural unit derived from a compound having (meth)acryloyl group is (meth)acrylic resin.

When the thermoplastic resin is a copolymer of ethylene and vinyl monomer, from the viewpoint of obtaining an appropriate melting temperature and suppressing the bleed of a plasticizer from the composition, the amount of the vinyl monomer is preferably 5% to 50% by mass, more preferably 10% to 45% by mass, further preferably 15% to 40% by mass, particularly preferably 20% by weight to 40% by weight, further particularly preferably from 25% to 40% by weight, and extremely particularly preferably 30% by weight to 40% by weight, and the most preferably and 35% by weight to 40% by weight, relative to the total amount of the copolymer.

The preferred ranges of MFR, a melting temperature, a bending modulus, a durometer hardness, a weight-average molecular weight, and a glass transition temperature of the thermoplastic resin are the same as the preferred ranges of MFR, a melting temperature, a bending modulus, a durometer hardness, a weight-average molecular weight, and a glass transition temperature of the (meth)acrylic resin.

The amount of the thermoplastic resin is preferably 10% by mass to 90% by mass relative to the total amount of the second composition of the present disclosure. When the amount of the thermoplastic resin is 10% by mass or more, it is easy to retain an anti-aging agent, a porous material, and a plasticizer in the composition, and it is easy to improve shape retention. Also, when the amount of the thermoplastic resin is 90% by mass or less, the amount of an anti-aging agent, a porous material, and a plasticizer is ensured to a certain extent, and the effect of keeping the freshness of the plant is high. The amount of the thermoplastic resin is more preferably 15% by mass or more, further preferably 20% by mass or more, and particularly preferably 25% by mass or more, relative to the total amount of the second composition of the present disclosure. On the other hand, from the viewpoint of more exhibiting the effect of keeping the freshness of the plant, the amount of the thermoplastic resin is more preferably 85% by mass or less, further preferably 75% by mass or less, particularly preferably 60% by mass or less, further particularly preferably 50% by mass or less, and the most preferably 40% by mass or less, relative to the total amount of the second composition of the present disclosure.

### (Anti-Aging Agent, Porous Material, and Plasticizer)

Preferred embodiments of the anti-aging agent comprised in the second composition of the present disclosure are the same as the preferred embodiments of the anti-aging agent comprised in the first composition of the present disclosure.

Preferred embodiments of the porous material comprised in the second composition of the present disclosure are the same as the preferred embodiments of the porous material comprised in the first composition of the present disclosure.

Preferred embodiments of the plasticizer comprised in the second composition of the present disclosure are the same as the preferred embodiments of the plasticizer comprised in the first composition of the present disclosure.

That is, the (meth)acrylic resin explained in the above section of the first composition can be read as “a thermoplastic resin”, and the first composition can be read as “second composition”.

Since the second composition of the present disclosure includes a thermoplastic resin and a plasticizer, the excessive increase in torque during kneading is suppressed. Accordingly, the heat generation due to an increase in torque can be suppressed, and the temperature rise of the kneaded material is suppressed. Accordingly, the volatilization and decomposition of the anti-aging agent comprised in the second composition is suppressed.

### (Other Ingredients)

The second composition of the present disclosure may comprise other ingredients other than a thermoplastic resin, an anti-aging agent, a porous material, and a plasticizer.

The other ingredients are for example, a resin other than a thermoplastic resin, and known additives such as an antioxidant, a neutralizer, a crosslinking agent, a heat stabilizer, a weathering agent, a pigment, a filer, a lubricant, a flame retardant, and the others.

The other ingredients comprised in the second composition of the present disclosure may be only one species thereof, or may be two or more species thereof.

The viscosity at 150° C. of the second composition of the present disclosure is, from the viewpoint of suppressing the excessive increase in torque during kneading, preferably from 100 Pa·s to 15000 Pa·s, more preferably from 500 Pa·s to 10000 Pa·s, and further preferably from 1000 Pa·s to 6000 Pa·s.

The composition of the present disclosure is used to keep the freshness of plant and can be applied to various component materials.

The composition of the present disclosure is used to keep the freshness of plant, and can be applied to plate-shaped bodies (sheets, films, etc.), labels, packaging materials (bags, boxes, containers, etc.), coating agents (liquid form or solid form), fabrics, granules, capsules, and tubes.

The plate-shaped bodies include sheet and film. The sheet and film may be a molded product formed by molding the composition of the present disclosure into a sheet or a film, or may be a sheet or a film formed by laminating a layer comprising the composition of the present disclosure and another layer. For example, the freshness of the plant can be kept by covering the plant with a sheet or a film comprising the composition of the present disclosure.

The label is preferably a stack of a layer comprising the composition of the present disclosure and an adhesive layer. For example, by affixing a label comprising the composition of the present disclosure to a plant, the freshness of the plant can be kept.

The packaging material include bag, box, container, and the others. The bag, the box, and the container may be a molded product formed by molding the composition of the present disclosure into a desired shape (for example, a bag shape, a box shape, etc.), or a processed body obtained by processing a stack formed by laminating a layer comprising the composition of the present disclosure and another layer into a desired shape. For example, the freshness of a plant can be kept by storing the plant in a bag, a box, or a container comprising the composition of the present disclosure.

The coating agent can be produced, for example, by adjusting the concentration of solid portion of the composition of the present disclosure to a coatable concentration. For example, the freshness of the plant can be kept by applying a coating agent comprising the composition of the present disclosure to the plant.

The coating agent may be liquid or solid. When coating agent is in liquid form, it can be for example, placed in a spray can and be applied by spraying.

The fabrics can be produced, for example, by spinning compositions of the present disclosure or by impregnating fabrics or threads with compositions of the present disclosure. For example, by covering a plant with a fabric comprising the composition of the present disclosure, the freshness of the plant can be kept.

The granules can be produced, for example, by processing the composition of the present disclosure into a desired shape (eg, tubes, pellets, etc.). By placing the granules comprising the composition of the present disclosure near the plant, the freshness of the plant can be kept.

The capsules and the tubes can be produced, for example, by encapsulating the compositions of the present disclosure. By placing the capsules or the tubes comprising the composition of the present disclosure near the plant, the freshness of the plant can be kept.

### [Molded Product]

The composition of the present disclosure can be molded into a molded product.

The molded product can be produced by, for example, molding by known molding methods such as injection molding, an extrusion molding, a press molding, a slush (powder) molding, or the others. The shape of the molded product may be determined as appropriate depending on the conditions or purpose of using the molded product, and is not particularly limited. The shape of the molded product is for example, a rod shape, a flat plate shape, a mesh shape, a round shape, a spherical shape, a fan shape, and a triangular shape. The molded product may be a molded product processed into a net, a fiber, a nonwoven a fabric, a sheet, a film, a tube, a pellet, or the others.

### [Composite Product]

Also, the composition of the present disclosure can be combined with other materials to form a composite product.

The composite product can be produced, for example, by combining the composition of the present disclosure with a molded product that is incompatible with the composition of the present disclosure. The shape of the composite product may be determined as appropriate depending on the conditions or purpose of using the composite product, and is not particularly limited. The shape of the composite product is for example, a rod shape, a flat plate shape, a mesh shape, a round shape, a spherical shape, a fan shape, and a triangular shape. The composite product may be a composite product processed into a net, a fiber, a nonwoven fabric, a sheet, a film, a tube, a pellet, or the others.

The materials of the molded product that is incompatible with the composition of the present disclosure is for example, resins, metals, ceramics, glasses, plants and derivatives thereof, as well as animal leather and hair.

The methods for combining the composition of the present disclosure and a molded product that is incompatible with the composition of the present disclosure are for example, a method by immersing the molded product in a liquid composition; a method by applying the composition to the molded product with press-fitting; a method of adding the molded product to a liquid composition and optionally stirring; a method of applying the liquid composition to the molded product; a method of attaching a sheet-like composition to the molded product; and a method of knitting together the molded product and a molded product of the composition.

### [Stack]

Also, the composition of the present disclosure can be a stack comprising the composition of the present disclosure. For example, the stack may be a stack comprising the first layer comprising the composition of the present disclosure and the second layer not comprising the composition of the present disclosure.

The first layer may be a layer comprising the composition of the present disclosure, and may be a single layer or a multilayer. From the viewpoint of easiness of producing the stack, the first layer is preferably a single layer.

When the first layer is a multilayer, each layer may be the same layer, or may be a different layer that is different each other in constitution, and thickness, etc. The amount of the composition of the present disclosure comprised in the first layer can be appropriately set depending on the use of the stack, but it is preferably 50% by mass or more, more preferably 60% by mass or more, further preferably 70% by mass or more, and particularly preferably at least 80% by mass, relative to the total amount of the first layer. Also, the upper limit of the above amount is not particularly limited, and is, for example, 100% by mass. That is, the first layer may be a layer composed of the composition of the present disclosure.

From the viewpoint of exhibiting the effect of keeping the freshness of the plant, the second layer is preferably a layer having a permeability against the anti-aging agent comprised in the composition of the present disclosure, and water. The layer with a permeability against anti-aging agent and water is a layer that meets the requirements defined by the following method.

Three (3) g of an anti-aging agent and 3 g of pure water are put into a moisture permeable cup with a diameter of 60 mm for evaluating moisture permeability of moisture-proof packaging materials specified in JIS Z 0208, and the second layer is used instead of the moisture-proof packaging material, and the cup is sealed. After 24 hours, the mass of the moisture-permeable cup is measured. After measuring the mass of the moisture permeable cup, the moisture-permeable cup is placed in an oven at 40° C. When the mass decreases by 0.5 mg or more from the initial mass, this layer is determined as a layer that has a permeability against anti-aging agent and water. Also, the value of the amount of mass loss measured as described above is defined as the transmittance.

The transmittance of the second layer against anti-aging agent and water is, from the viewpoint of expanding the duration keeping the freshness of plant, preferably 0.5 mg to 3 g, more preferably 0.5 mg to 1 g, further preferably 1 mg to 500 mmg, and particularly preferably 1 mg to 100 mg.

The material constituting the second layer may be selected so as to make the permeability its desired degree depending on the type of anti-aging agent comprised in the composition of the present disclosure, and is not particularly limited, but is preferably a resin.

The resin constituting the second layer is for example, polyolefins such as polyethylene and polypropylene, ethylene copolymers such as ethylene-vinyl acetate copolymer, biodegradable resins such as polylactic acid, and polychlorinated vinyl. From the viewpoint of easiness of obtaining a good permeability against anti-aging agent and water, the second layer preferably comprises at least one resin selected from the group consisting of ethylene copolymer and polyolefin.

The second layer may have through-holes to adjust the permeability of the second layer against anti-aging agent and water. The diameter of the through-hole may be adjusted as appropriate, but is preferably 0.1 μm to 500 μm. When the second layer has through-holes, the anti-aging agent and water are permeated through the second layer through the through-holes and are volatilized. Accordingly, when the second layer has through-holes, the second layer does not need to be composed of a material that has the permeability against anti-aging agent and water, and the material that constitutes the second layer may be any materials including known resin, metal, glass, and the others. The material constituting the second layer is, from the viewpoint of its processability, preferably a thermoplastic resin.

The second layer may be a fibrous material such as cloth or paper. The fibers in the textile material are for example, cellulose fibers, polyethylene fibers, polypropylene fibers, polyethylene telephthalate fibers, metal fibers, animal hair, and mixtures thereof. The fiber material may comprise an adhesive agent to connect the fibers; a filler to fill the gaps between the fibers; or a coloring agent such as a dye, pigment, or paint to impart color or pattern.

The second layer may be a single layer or a multilayer. The multilayer second layer is for example, a laminated paper made by coating paper with polyolefin. In this case, for example, in a stack having at least the layer constitution of the second layer/the first layer, the polyolefin layer as a multilayer of the second layer may be the surface in contact with the first layer, or the paper of the second layer may be the surface that is in contact with the first layer. The layer may be the surface in contact with the first layer.

Also, a stack in which the first layer is a single layer, the second layer is a single layer or a multilayer, one side face of the second layer is in contact with the first layer, and the other side face of the second layer is the outermost surface may be a multilayer stack in which the polyolefin layer as a multilayer of the second layer is the surface in contact with the first layer, and the paper layer of the second layer is the outermost surface. It is preferably a stack in which the polyolefin layer of the second layer is the surface in contact with the first layer, and the paper layer of the second layer is the outermost surface.

The stack that comprises the first layer comprising the composition of the present disclosure and the second layer not comprising the composition of the present disclosure may further comprising the third layer that is different from the first layer and the second layer. The third layer is for example, at least one layer selected from the group consisting of an adhesive layer, a surface protection layer, a colored layer, an anti-aging agent permeable barrier layer, a design layer, and an ultraviolet absorbing layer.

One form of stack is a stack that comprises the first layer comprising the composition of the present disclosure and the second layer not comprising the composition of the present disclosure. The above stack may be, for example, a stack in which the first layer and the second layer are stacked in this order, or a stack in which the first layer, the second layer, and the first layer are stacked in this order. A stack in which the second layer, the first layer, and the second layer are stacked in this order can release anti-aging agent from both side surfaces of the stack, and can supply anti-aging agent to the environment at a high rate. The above-mentioned stack is for example, a stack having at least the layer constitution of the second layer/the first layer, a stack having at least the layer constitution of the second layer/the first layer/the second layer, and a stack having at least the layer constitution of the second layer/the first layer/the second layer/the first layer/the second layer. Here, in the layer constitution such as the second layer/the first layer/the second layer, the second layer/the first layer/the second layer/the first layer/the second layer, each the first layer may be the same as or different from each other, and each the second layer may be the same as or different from each other. Further, the third layer may be further laminated on the above layer constitution. The stack of the present disclosure may be a stack having a laminated structure comprising in order the first resin layer (the second layer), a plate-shaped body of the present disclosure (the first layer), and the second resin layer (the second layer), and the first resin layer and the second resin layer may be a resin sheet.

Another form of stack is a stack comprising the first layer consisting of the composition of the present disclosure, the second layer not comprising the composition of the present disclosure, and the third layer that is different from the first layer and the second layer, that has at least a layer constitution laminated in the order of the second layer/the first layer/the third layer. A stack laminated in this form can increase the value of the product by changing the release rate of anti-aging agent from both side faces of the stack, or by giving the third layer a function different from that of the anti-aging agent. For example, by making the third layer a non-permeable material, the effect of keeping the freshness of plant can be exhibited only on one side of the space separated by the stack. Also, by making the third layer an adhesive material, the stack can be attached to any suitable surface. Also, the third layer may be further laminated on the above layered construction.

Another form of stack is a stack in which the first layer consisting of the composition of the present disclosure, and the second layer not comprising the composition of the present disclosure are laminated in the order of the first layer/the second layer. A stack laminated in this form can improve the mechanical properties of the stack while ensuring the release of anti-aging agent, and can avoid a direct contact with the first layer comprising the anti-aging agent. Also, when the first layer is sticky, the stack can be attached onto any surface. Also, the third layer may be further laminated on the above layered construction.

In a preferred embodiment of the stack of the present invention, a stack may be a stack in which the first layer is a single layer, the second layer is a single layer or a multilayer, and one side surface of the second layer is in contact with the first layer, and the other side surface of the second layer is in contact with the first layer, and the other side surface of the second layer is the outermost surface. The above-mentioned stack is for example, a stack that comprises a layer constitution of a single-layer of the first layer/a single-layer or multi-layer of the second layer in which the surface of the second layer that does not contact the first layer is the outermost surface, and a stack that comprises a layer constitution of the second layer/a single layer of the first layer/the second layer in which at least one second layer of the two second layers, the surface not in contact with the first layer is the outermost surface. The above stack is for example, a stack that has a layer constitution in which the second layer/a single layer of the first layer are laminated in this order, a stack that has a layer constitution in which the second layer/a single layer of the first layer/the third layer is laminated in this order, a stack that the second layer/a single layer of the first layer/the second layer are laminated in this order, and a stack that the second layer/a single layer of the first layer/the second layer/the third layer are laminated in this order.

The method for producing the stack is not particularly limited. The producing method is for example, a method of applying the composition of the present disclosure liquefied by thermal melting or by dissolving in an appropriate solvent to the second layer having a sheet-like shape; a method of applying the composition for the second layer liquefied by thermal melting or by dissolving in an appropriate solvent to the first layer having a sheet-like shape; and a method of crimping the first layer having a sheet-like shape and the second layer at room temperature or in heating state. When both the composition for the first layer and the composition for the second layer have thermoplasticity, the producing method is for example, a method of coextruding these compositions, a method of multilayer injection molding, a method of composite spinning, and a method of extrusion lamination.

When it is necessary to process the second layer at a high temperature, the anti-aging agent comprised in the first layer may be volatilized, decomposed, or polymerized due to the high temperature conditions for processing the second layer. From the viewpoint of easiness of preventing the degeneration of anti-aging agent, a stack is preferably produced by a method of applying the material of the other layer by heat melting or by dissolving it in solvent to either of the first layer and the second layer, or a method by extrusion laminating the first layer to the second layer.

The present disclosure may be the following embodiments.

### Embodiment 1

A composition comprising (meth)acrylic resin, an anti-aging agent, and a porous material.

### Embodiment 2

A composition comprising (meth)acrylic resin, an anti-aging agent, a porous material, and a plasticizer.

### Embodiment 3

A composition comprising a thermoplastic resin, an anti-aging agent, a porous material, and a plasticizer.

Preferred of embodiment of the (meth)acrylic resin, the thermoplastic resin, the anti-aging agent, the porous material, and the plasticizer are as described above.

Also, the present disclosure may be the following embodiments.

### Embodiment A

A method for keeping the freshness of a plant which comprises a step of preparing a composition comprising (meth)acrylic resin, anti-aging agent and porous material; a step of producing a molded product comprising the composition; and a step of covering a plant with the molded product.

### Embodiment B

A method for keeping the freshness of a plant which comprises a step of preparing a composition comprising (meth)acrylic resin, anti-aging agent, and porous material; a step of producing a stack in which a layer comprising the above composition and an adhesive layer are laminated; and a step of pasting the stack to a plant or a packaging material that covers the plant;

### Embodiment C

A method for keeping the freshness of a plant which comprises a step of preparing a composition comprising (meth)acrylic resin, anti-aging agent, and porous material; a step of producing a coating agent comprising the above composition; and a step of pasting the coating agent to a plant or a packaging material that covers the plant.

The “step of producing a composition comprising (meth)acrylic resin, anti-aging agent, and porous material” in the above embodiment A to embodiment C may be replaced with “step of producing a composition comprising (meth)acrylic resin, anti-aging agent, and porous material”, or “step of producing a composition comprising porous material, a plasticizer” or “a step of producing a composition comprising a thermoplastic resin, anti-aging agent, porous material, and a plasticizer.”

In the embodiment A, “cover the plant” may refer to covering the entire plant, or may refer to covering only a part of the plant. Alternatively, the use form may be the form in which the molded product may contact with the plant to cover the plant, or the form in which the plant may be placed in molded products such as a bag-shaped, and box-shaped products without contacting the molded product with the plants.

A “method for keeping the freshness of a plant” is regarded as a method that keeps the freshness of a plant if the change in color is suppressed compared to the change in color of a plant over a predetermined period when the method is not used.

### EXAMPLES

Hereinafter, an embodiment of the present disclosure is described in more detail by Examples, but the present disclosure is not limited to these Examples.

### Example 1

Ethylene-methyl acrylate copolymer which is acrylic resin (amount of structural unit derived from methyl acrylate: 35% by mass, product name “Acryft (registered trademark)”, manufactured by Sumitomo Chemical Co., Ltd.) 33 g, diatomaceous earth (product name “Radiolite #900”, manufactured by Showa Kagaku Kogyo Co., Ltd.; porous material) 40 g, 1-methylcyclopropene/α-cyclodextrin inclusion complex (1-methylcyclopropene amount 3.3% by mass; anti-aging agent) 10 g, and a plasticizer (tributyl acetyl citrate) 17 g were put into a kneader (product name: Labo Plastomill, model 65C150, manufactured by Toyo Seiki Seisaku-sho Ltd.) with a jacket temperature of 80° C., and kneaded at a rotational speed of 100 rpm for 30 minutes to produce a composition.

Here the above acrylic resin had an MFR of 40 g/10 minutes, a melting temperature of 50° C., a bending modulus of 3 MPa, a durometer hardness of 10, and a weight average molecular weight of 40000.

The viscosity at 150° C. of this composition was 3700 Pa·s.

The diatomaceous earth had an average pore diameter of 100 nm, a water content of 0.3%, an average particle diameter of 28.7 μm, and an oil absorption amount of 130 ml/100 g.

### Example 2

A composition was produced by a similar procedure as Example 1 except for replacing the acrylic resin in Example 1 with ethylene-methyl acrylate copolymer which is an acrylic resin (amount of structural unit derived from methyl acrylate: 30% by mass, product name “Acryft (registered trademark)”, manufactured by Sumitomo Chemical Co., Ltd.).

Here the acrylic resin had an MFR of 7 g/10 minutes, a melting temperature of 64° C., a bending modulus of 7 MPa, a durometer hardness of 24, and a weight average molecular weight of 90000.

The viscosity at 150° C. of the composition was 6600 Pa·s.

### Reference Example 1

A composition was produced by a similar procedure as Example 1 except for replacing the acrylic resin in Example 1 with ethylene-vinyl acetate copolymer (amount of structural unit derived from vinyl acetate: 28% by mass, product name “Sumitate (registered trademark)”, manufactured by Sumitomo Chemical Co., Ltd.)

Here the ethylene-vinyl acetate copolymer had an MFR of 7 g/10 minutes, a melting temperature of 70° C., a bending modulus of 13 MPa, a durometer hardness of 30, and a weight average molecular weight of 64000.

The viscosity at 150° C. of the composition was 11000 Pa·s.

### Comparative Example 1

A composition was produced by a similar procedure as Example 1 except that the acrylic resin in Example 1 was replaced with ethylene-vinyl acetate copolymer (amount of structural unit derived from vinyl acetate: 28% by mass, product name “Sumitate (registered trademark)”, manufactured by Sumitomo Chemical Co., Ltd.), the amount of ethylene-vinyl acetate copolymer was changed to 41 g, the amount of diatomaceous earth was changed to 49 g, the amount of 1-methylcyclopropene/α-cyclodextrin inclusion complex was changed to 10 g, and that a plasticizer was not used to produce a composition.

The viscosity at 150° C. of the composition was 16000 Pa·s.

The torque applied to the kneader during production and the temperature of the kneaded product during production were measured for the compositions of Example 1, Example 2, Reference Example 1, and Comparative Example 1. Also, the appearance and the odor of the obtained composition were evaluated. The results of the measurements and the evaluation are as follows.

### (Torque)

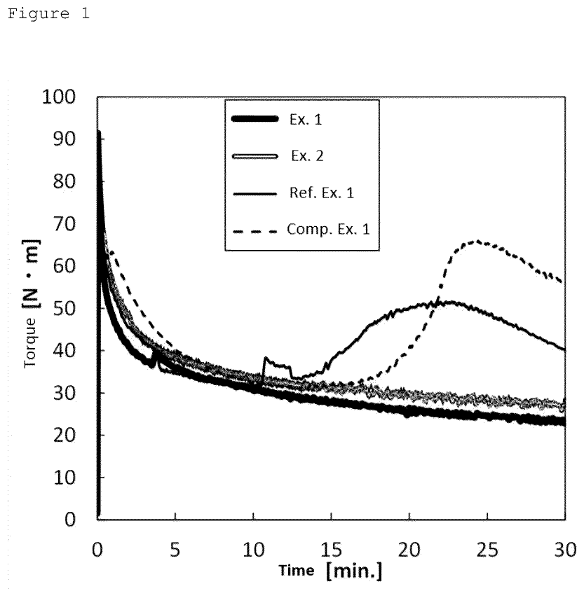

FIG. 1 shows the results of the torque applied to the kneader during production.

As shown in FIG. 1, in Example 1, the torque applied to the kneading machine decreased over time, and the maximum torque after 5 minutes from the start of kneading was 35 N·m, which was a sufficiently small torque. In Example 2, the torque applied to the kneader decreased over time, and the maximum torque after 5 minutes from the start of kneading was 37 N·m, which was a sufficiently small torque.

On the other hand, in Reference Example 1, the torque applied to the kneader turned to increase after 10 minutes from the start of kneading, and the maximum torque after 5 minutes of kneading was 52 N·m.

In Comparative Example 1, the torque applied to the kneader turned to increase after 12 minutes from the start of kneading, and the maximum torque after 5 minutes of kneading was 66 N·m, indicating an excessive increase in torque.

### (Resin Temperature)

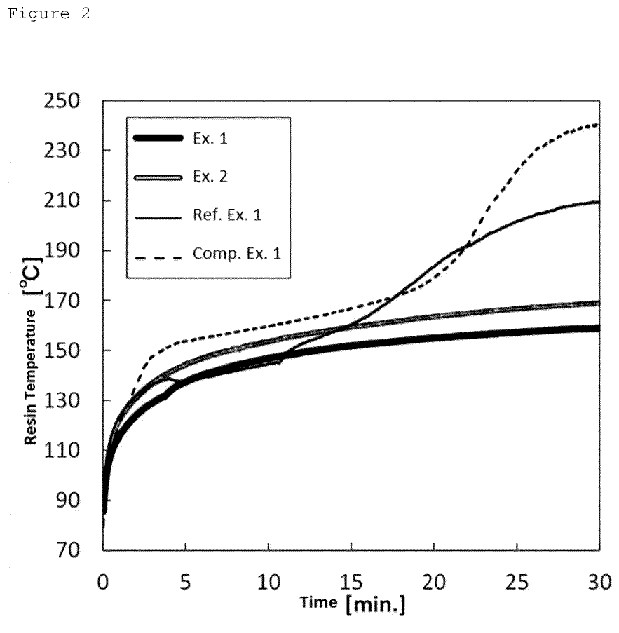

FIG. 2 shows the results of the temperature of the kneaded material during production (“resin temperature” in FIG. 2).

As shown in FIG. 2, in Example 1, the resin temperature increased gradually over time after the start of kneading, and the maximum value was 159° C., and no excessive temperature rise was observed. In Example 2, the resin temperature increased gradually over time after the start of kneading, and the maximum value was 169° C., and no excessive temperature rise was observed.

On the other hand, in Reference Example 1, the resin temperature increased rapidly after about 10 minutes from the start of kneading, and the maximum value was 209° C.

In Comparative Example 1, the resin temperature increased rapidly after about 10 minutes from the start of kneading, and the maximum value was 241° C., which was outside of the appropriate processing temperature range.

### (Appearance and Odor)

The appearance of the obtained composition was visually observed and the presence or absence of odor of the composition was evaluated.

In Examples 1 and 2, the appearance of the compositions was light gray, and no odor was observed, which was good.

On the other hand, in Reference Example 1 and Comparative Example 1, the appearance of the obtained compositions was burnt brownish gray. Also, since the obtained compositions had an acetic acid odor, it was considered that the ingredients within the composition had decomposed.

Next, a stack (sheet) was prepared using the composition of Example 1.

The composition of Example 1 was press-molded at 80° C. and a pressure of 20 MPa to obtain a sheet-like molded product with 200 mm long×200 mm wide×0.2 mm thick. Next, a 0.03 mm thick low-density polyethylene film whose resin surface was corona-treated was pressed onto both faces of the molded product using a hand roller so that the corona-treated surface was in contact with the molded product, and a sheet was prepared. The obtained sheet was laminated in the order of the second layer/the first layer/the second layer in which the layer composed of the composition of the present disclosure was the first layer and the low density polyethylene film was the second layer.

A release test and a freshness retention test were conducted using the obtained stack. The test methods and results are as follows.

### (Release Test)

The produced stack was cut into 50 mm squares to obtain test samples. The test sample was placed in a constant temperature and humidity chamber at 25° C. and 95 RH. The release tests were conducted and the samples were collected after 7 days and 14 days.

The collected test samples were sealed in a vial together with 100 μL of pure water. Heating was performed at 150° C. for 20 minutes to release all 1-methylcyclopropene that were remained in the test sample. Thereafter, the gas components in the vial were separated and quantified using a gas chromatography mass spectrometer. Thereby, the remaining amounts of 1-methylcyclopropene after 7 days and 14 days were calculated. Each test was conducted three times, and the average value was adopted.

As a result, the remaining amount of 1-methylcyclopropene was 39% by mass after 7 days from the start of the test, and 15% by mass after 14 days from the start of the test, relative to the amount of 1-methylcyclopropene in the test sample that was not subjected to the release test. It was confirmed that 1-methylcyclopropene was continuously released over two weeks.

### (Keeping Freshness Test)

The produced stack was cut into 50 mm squares to obtain test samples.

Two Japanese pears (Hosui) from Chiba Prefecture and the above test sample were placed in a polypropylene bag (Bodon Pack with holes #20 No. 12) which was commonly used for packaging greengrocery, and the opening part was closed with tape to prepare a treated sample.

Separately, two Japanese pears (Hosui) from Chiba Prefecture were placed in a polypropylene bag and the opening part was closed with tape to prepare an untreated sample.

The treated samples and the untreated samples were incubated in a temperature-controlled room kept in 25° C. for 14 days. Before and after the incubation, the brightness and the chromaticity of the pear surface was measured using a colorimeter (product name “Spectro-guide 45/0 gloss”, manufactured by BYK-Gardner GmbH) on the basis of the CIE1976L*a*b* color space, and the color difference DE before and after the standing was calculated. The test was conducted three times, and the average value of the color difference ΔE was calculated.

Also, the hardness of the pear before and after the incubation was measured using a fruit hardness meter (product name “KM-5”, manufactured by Fujiwara Scientific Co., Ltd.), and the difference in hardness before and after the incubation was calculated. The test was conducted three times, and the average value of the hardness difference was calculated.

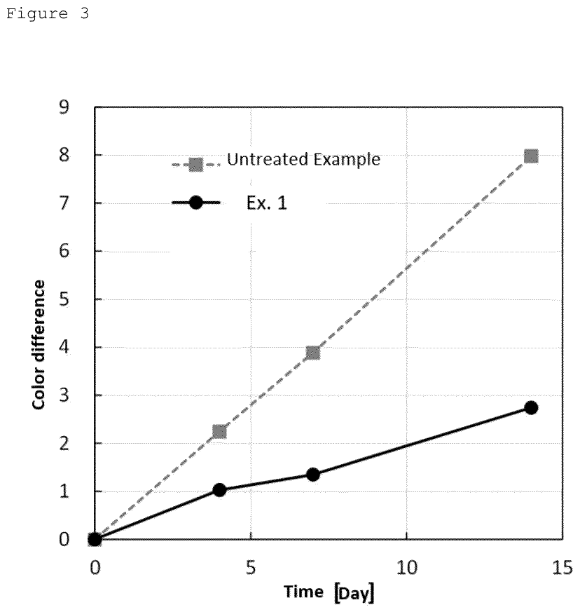

FIG. 3 shows the calculation results of the color difference ΔE.

As shown in FIG. 3, the treated sample had a color difference ΔE of 2.8 after 14 days, whereas the untreated sample had a color difference ΔE of 8.0.

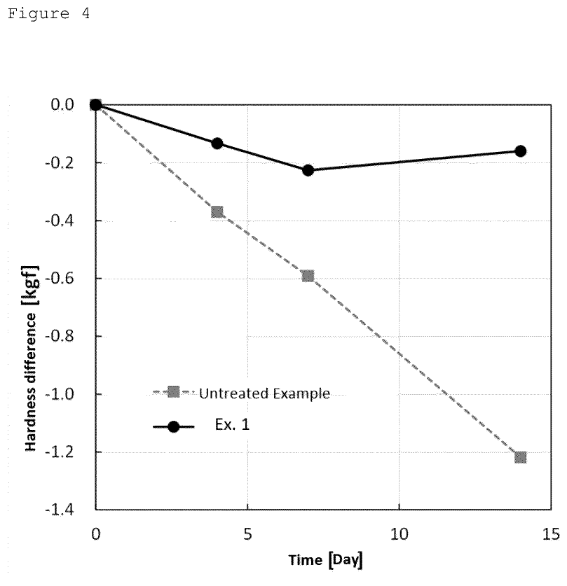

FIG. 4 shows the calculation results of the hardness difference.

As shown in FIG. 4, in the treated sample, the hardness of the pear was decreased by 0.2 kgf after 14 days, whereas in the untreated sample, the hardness of the pear was decreased by 1.2 kgf.

Furthermore, in the treated samples, there was no change in the appearance of the pears after 14 days, and the pears were maintained their firmness. On the other hand, in the untreated sample, the pears were turned brown after 14 days, the skin was softened, and the juice was leaked into the bag.

It was found that the composition of the present disclosure comprises a (meth)acrylic resin, an anti-aging agent, and a porous material, and has an excellent effect of keeping freshness.

Also, it was found that the composition of the present disclosure comprises a thermoplastic resin, an anti-aging agent, a porous material, and a plasticizer, and has an excellent effect of keeping freshness.

1. A plant freshness-keeping composition comprising a (meth)acrylic resin, an anti-aging agent, and a porous material.

2. The plant freshness-keeping composition according to claim 1 wherein the (meth)acrylic resin comprises a structural unit derived from (meth)acrylic acid ester and a structural unit derived from α-olefin.

3. The plant freshness-keeping composition according to claim 2 wherein the structural unit derived from (meth)acrylic acid ester is a structural unit derived from (meth)acrylic acid alkyl ester having alkyl group of 1 to 4 carbon atoms.

4. The plant freshness-keeping composition according to claim 2 wherein the amount of the structural unit derived from (meth)acrylic acid ester is 5% by mass to 50% by mass relative to the total amount of the (meth)acrylic resin.

5. The plant freshness-keeping composition according to claim 1 wherein the amount of the (meth)acrylic resin is 15% by mass to 90% by mass relative to the total amount of the (meth)acrylic resin.

6. The plant freshness-keeping composition according to claim 1 wherein the composition further comprises a plasticizer.

7. A plant freshness-keeping composition comprising a thermoplastic resin, an anti-aging agent, a porous material, and a plasticizer.

8. The plant freshness-keeping composition according to claim 6 wherein the plasticizer is at least one selected from the group consisting of a fatty acid ester, an acetylcitrate ester, a phthalate ester, an isophthalate ester, and a terephthalate ester.

9. The plant freshness-keeping composition according to claim 1 wherein a viscosity at 150° C. is 100 Pa·s to 15000 Pa·s.

10. The plant freshness-keeping composition according to claim 1 wherein the anti-aging agent comprises a cyclopropene compound.

11. The plant freshness-keeping composition according to claim 1 wherein the porous material is an inorganic porous material comprising silicon.

12. The plant freshness-keeping composition according to claim 1 wherein the porous material comprises a diatomaceous earth.

13. A plate-shaped body comprising the plant freshness-keeping composition according to claim 1.

14. A stack comprising the first layer comprising the plant freshness-keeping composition according to claim 1 and the second layer.

15. A label comprising the plant freshness-keeping composition according to claim 1.

16. A packaging material comprising the plant freshness-keeping composition according to claim 1.

17. The plant freshness-keeping composition according to claim 7 wherein the plasticizer is at least one selected from the group consisting of a fatty acid ester, an acetylcitrate ester, a phthalate ester, an isophthalate ester, and a terephthalate ester.
